(19) United States
(12) Patent Application Publication
(10) Pub. No.: US 2010/0283741 A1
(43) Pub. Date: Nov. 11, 2010

(54) CONTEXTUALLY ADAPTIVE INPUT DEVICE

(75) Inventors: R. Siegfried Heintze, Bellevue, WA (US); Hakon Strande, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/436,602

(22) Filed: May 6, 2009

(51) Int. Cl. G06F 3/041

(52) U.S. Cl. 345/173

(57) ABSTRACT

Embodiments relating to a contextually adaptive input device are presented. As one example embodiment, a computing system is provided, which includes an adaptive input device including an active display region for receiving touch input and a passive display region for presenting graphical content. The computing system further includes a computing device operatively coupled with the adaptive input device and including an adaptive device module. The adaptive device module is configured to receive a touch input via the active display region of the adaptive input device; present graphical content at the passive display region of the adaptive input device; and vary the graphical content presented at the passive display region responsive to a change of a context of the adaptive input device.

### BACKGROUND

Computing systems can be used for work, play, and everything in between. To increase productivity and improve the user experience, attempts have been made to design input devices that offer the user an intuitive and powerful mechanism for issuing commands and/or inputting data.

### SUMMARY

Embodiments relating to a contextually adaptive input device are presented. As one example embodiment, a computing system is provided, which includes an adaptive input device including an active display region for receiving touch input and a passive display region for presenting graphical content. The computing system further includes a computing device operatively coupled with the adaptive input device and including an adaptive device module. The adaptive device module is configured to receive a touch input via the active display region of the adaptive input device; present graphical content at the passive display region of the adaptive input device; and vary the graphical content presented at the passive display region responsive to a change of a context of the adaptive input device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A illustrates a system including an adaptive input device in accordance with an embodiment of the present disclosure.

FIG. 1B illustrates dynamic updates to the visual appearance of the adaptive input device of FIG. 1A.

FIG. 2 is a sectional view of an adaptive keyboard in accordance with an embodiment of the present disclosure.

FIG. 3 is a schematic view of a computing system in accordance with an embodiment of the present disclosure.

FIG. 4 is a schematic view of example graphical content.

FIG. 5 is a flow chart depicting an example method of facilitating communication between an adaptive input device and a computing device.

FIGS. 6, 7, and 8 depict a sequence of events for an example adaptive input device.

### DETAILED DESCRIPTION

The present disclosure is related to an adaptive input device that can provide input to a variety of different computing systems. The adaptive input device may include one or more physical or virtual controls provided at one or more active display regions that a user can activate to effectuate a desired user input. The adaptive input device may further include one or more passive display regions, which are not capable of receiving user input, for presenting graphical content that may compliment the active display regions. The adaptive input device is capable of dynamically changing its visual appearance at one or more of the active display regions and/or passive display regions to provide visual feedback to a user and to facilitate user input. The visual appearance of the adaptive input device may be dynamically changed according to a variety of operating conditions. For example, the visual appearance of the adaptive input device may dynamically signal different contexts within a single application and/or different contexts in two or more different applications.

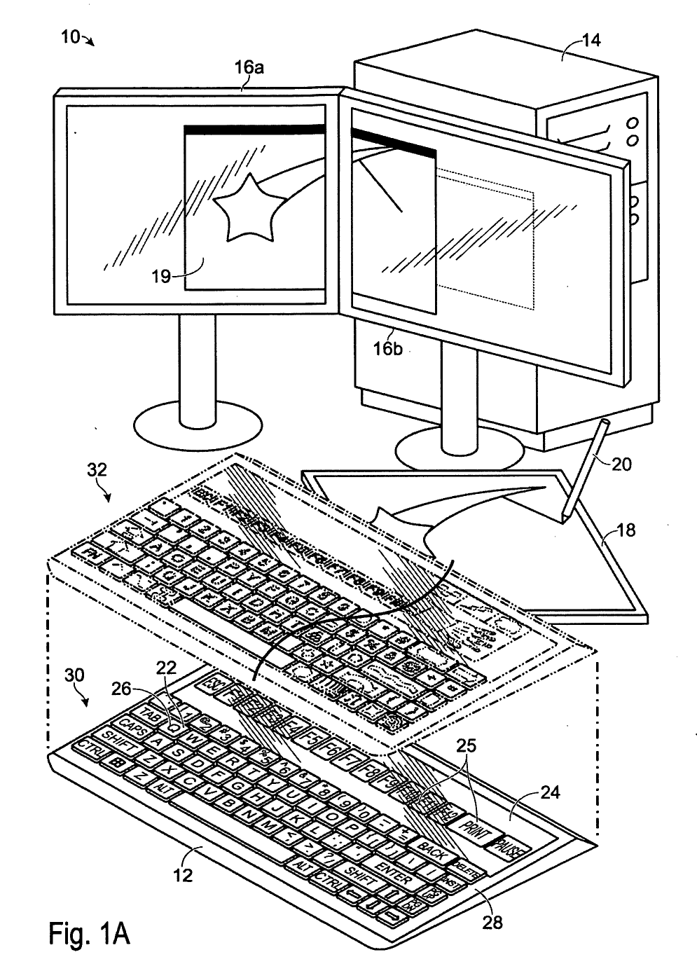

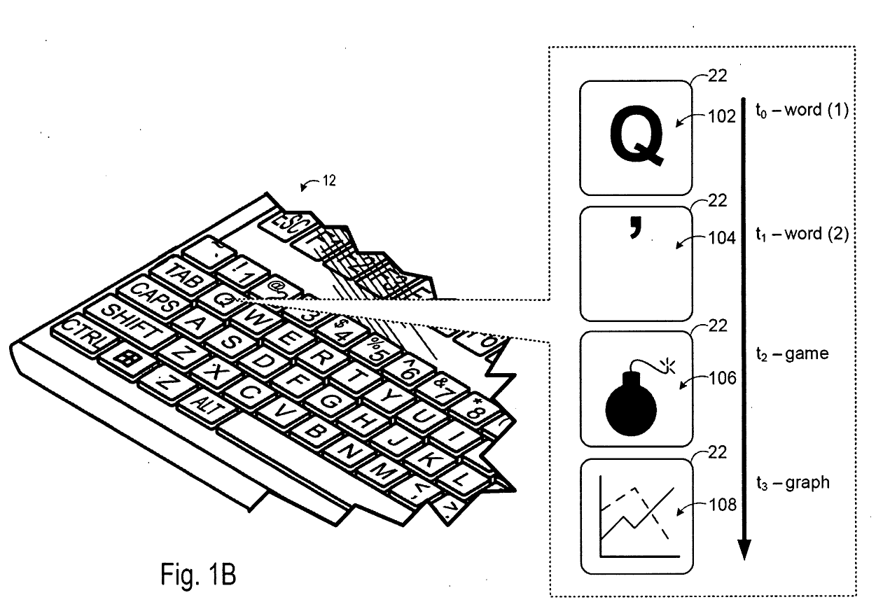

FIG. 1A shows a non-limiting example of a computing system 10 including an adaptive input device 12, such as an adaptive keyboard, with a dynamically changing appearance. The adaptive input device 12 is shown connected to a computing device 14. The computing device may be configured to process input received from adaptive input device 12. The computing device may also be configured to dynamically change an appearance of the adaptive input device 12.

Computing system 10 further includes monitor 16a and monitor 16b. While computing system 10 is shown including two monitors, it is to be understood that computing systems including fewer or more monitors are within the scope of this disclosure. The monitor(s) may be used to visually present visual information to a user.

Computing system 10 may further include a peripheral input device 18 receiving user input via a stylus 20, in this example. Computing device 14 may process an input received from the peripheral input device 18 and display a corresponding visual output 19 on the monitor(s). While a drawing tablet is shown as an exemplary peripheral input device, it is to be understood that the present disclosure is compatible with virtually any type of peripheral input device (e.g., keyboard, number pad, mouse, track pad, trackball, etc.).

In the illustrated embodiment, adaptive input device 12 includes a plurality of depressible keys (e.g., depressible buttons), such as depressible key 22, and touch-sensitive regions, such as touch-sensitive graphical display 24 for displaying virtual controls 25. The adaptive input device may be configured to recognize touch input when a key is pressed or otherwise activated. The adaptive input device 12 may also be configured to recognize touch input directed to a portion of touch-sensitive graphical display 24. In this way, the adaptive input device 12 may recognize user input.

Each of the depressible keys (e.g., depressible key 22) may have a dynamically changeable visual appearance. In particular, a key image 26 may be presented on a key, and such a key image may be adaptively updated. A key image may be changed to visually signal a changing functionality of the key, for example.

Similarly, the touch region 24 may have a dynamically changeable visual appearance. In particular, various types of touch images may be presented by the touch-sensitive graphical display, and such touch images may be adaptively updated. As an example, the touch-sensitive graphical display may be used to visually present one or more different touch images that serve as virtual controls (e.g., virtual buttons, virtual dials, virtual sliders, etc.), each of which may be activated responsive to a touch input directed to that touch image. The number, size, shape, color, and/or other aspects of the touch images can be changed to visually signal changing functionality of the virtual controls. It may be appreciated that one or more depressible keys may include touch-sensitive regions, as discussed in more detail below.

The adaptive keyboard may also present a background image (i.e., skin) in a passive display region 28 that is not occupied by depressible buttons, touch-sensitive graphical displays, or other input mechanisms. By contrast, the depressible buttons and touch-sensitive graphical displays of the adaptive input device that are configured to receive touch input may be referred to as active display regions of the adaptive input device, which are functionally distinct from the passive display regions.

The visual appearance of passive display region 28 also may be dynamically updated (i.e., skinned). The visual appearance of passive display region 28 may be set to create a desired contrast with the key images of the depressible buttons and/or the touch images of the touch-sensitive graphical displays, to create a desired ambiance, to signal a mode of operation, to indicate a parameter or condition of an application, or for virtually any other purpose, as described in detail below.

By adjusting one or more of the key images, such as key image 26, the touch images, and/or a background image presented at passive display region 28, the visual appearance of the adaptive input device 12 may be dynamically adjusted and customized. As non-limiting examples, FIG. 1A shows adaptive input device 12 with a first visual appearance 30 in solid lines, and an example second visual appearance 32 of adaptive input device 12 in dashed lines.

The visual appearance of different regions of the adaptive input device 12 may be customized based on a large variety of parameters. As further elaborated with reference to FIG. 1B, these may include, but not be limited to: a context of the adaptive input device, active applications, a parameter or condition of a focus application, an application context, a system context, system state changes, user preferences, application settings, system settings, machine-selected or user-selected skins, etc.

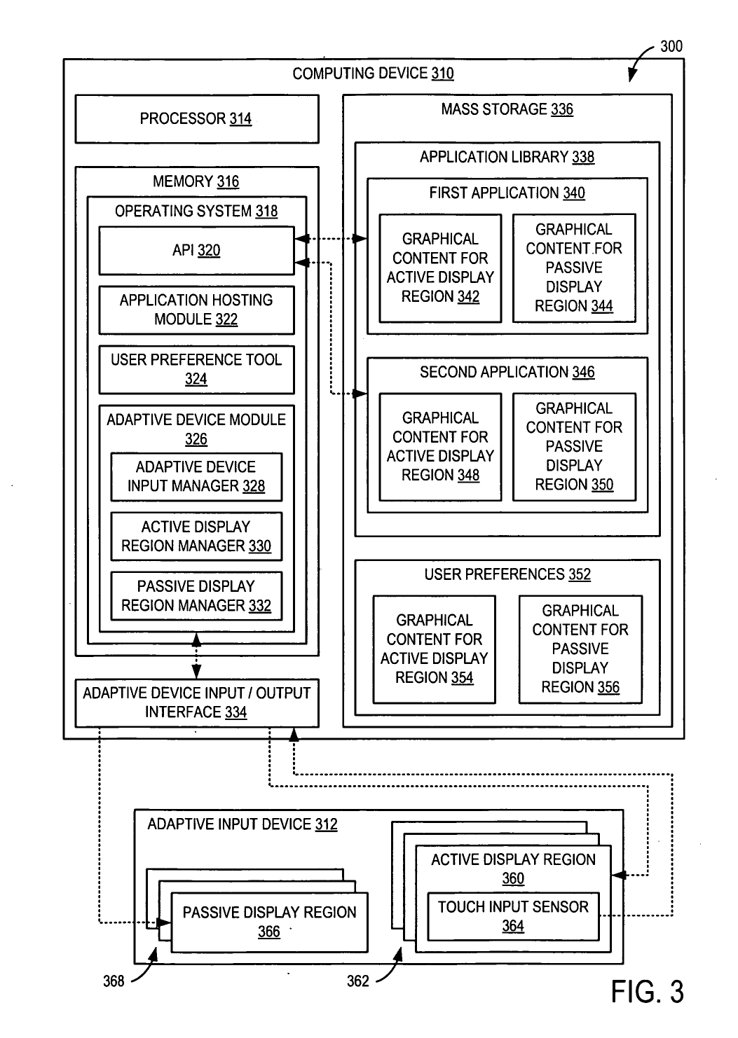

In one example, if a user selects a word processing application, the key images (e.g., key image 26) may be automatically updated to display a familiar QWERTY keyboard layout. Key images also may be automatically updated (e.g., without requiring input from the user) with icons, menu items, etc. from the selected application. For example, when using a word processing application, one or more key images may be used to present frequently used word processing operations such as “cut,” “paste,” “underline,” “bold,” etc. Furthermore, the touch-sensitive graphical display 24 may be automatically updated to display virtual controls tailored to controlling the word processing application. As an example, at t₀, FIG. 1B shows depressible key 22 of adaptive input device 12 visually presenting a Q-image 102 of a QWERTY keyboard. At t₁, FIG. 1B shows the depressible key 22 after it has dynamically changed to visually present an apostrophe-image 104 of a Dvorak keyboard in the same position that Q-image 102 was previously displayed. Further still, passive display region 28 may be updated as will be described in greater detail with reference to FIGS. 3-8.

In another example, if a user selects a gaming application, the depressible keys and/or touch-sensitive graphical display may be automatically updated to display frequently used gaming controls. For example, at t₂, FIG. 1B shows depressible key 22 after it has dynamically changed to visually present a bomb-image 106.

As still another example, if a user selects a graphing application, the depressible keys and/or touch-sensitive graphical display may be automatically updated to display frequently used graphing controls. For example, at t₃, FIG. 1B shows depressible key 22 after it has dynamically changed to visually present a line-plot-image 108.

As illustrated in FIG. 1B, the adaptive input device 12 dynamically changes to offer the user input options relevant to the task at hand. The entirety of the adaptive input device may be dynamically updated, and/or any subset of the adaptive input device may be dynamically updated. In other words, all of the depressible keys may be updated at the same time; each key may be updated independent of other depressible keys, or any configuration in between.

The user may, optionally, customize the visual appearance of the adaptive input device based on user preferences. For example, the user may adjust the graphical content that is presented at one or more of the active display regions and the passive display regions. This is explained in more detail with reference to FIGS. 3-8.

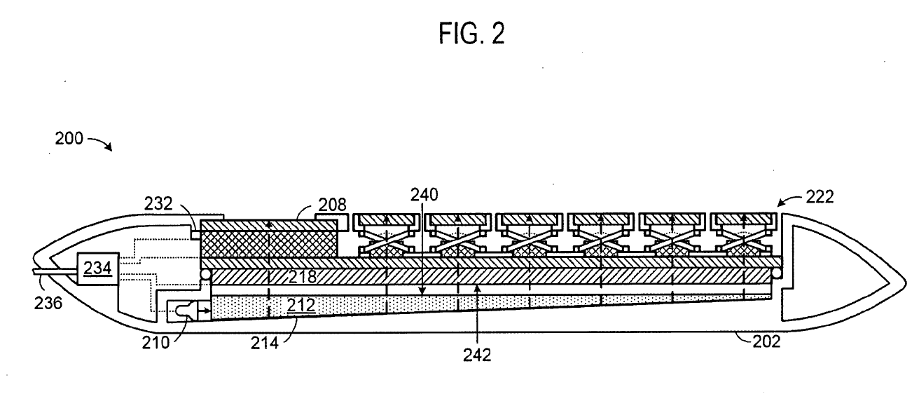

FIG. 2 is a sectional view of an example adaptive input device 200. While adaptive input device 200 is provided as a nonlimiting example, it is to be understood that the herein described methods of varying graphical content may be utilized with virtually any adaptive device including active and/or passive display regions. The adaptive input device 200 may be a dynamic rear-projected adaptive keyboard in which images may be dynamically generated within the body 202 of adaptive input device 200 and selectively projected onto the active display regions, including the plurality of depressible keys (e.g., depressible key 222) and touch regions (e.g., touch-sensitive graphical display 208), and passive display regions.

A light source 210 may be disposed within body 202 of adaptive input device 200. A light delivery system 212 may be positioned optically between light source 210 and a liquid crystal display 218 to deliver light produced by light source 210 to liquid crystal display 218. In some embodiments, light delivery system 212 may include an optical waveguide in the form of an optical wedge with an exit surface 240. Light provided by light source 210 may be internally reflected within the optical waveguide. A reflective surface 214 may direct the light provided by light source 210, including the internally reflected light, through light exit surface 240 of the optical waveguide to a light input surface 242 of liquid crystal display 218.

The liquid crystal display 218 is configured to receive and dynamically modulate light produced by light source 210 to create a plurality of display images that are respectively projected onto the plurality of depressible keys, touch regions, or passive display region (i.e., key images, touch images and/or background images).

The touch input display section 208 and/or the depressible keys (e.g., depressible key 222) may be configured to display images produced by liquid crystal display 218 and, optionally, to receive touch input from a user. The one or more display images may provide information to the user relating to control commands generated by touch input directed to touch input display section 208 and/or actuation of a depressible key (e.g., depressible key 222).

Touch input may be detected by one or more touch input sensors, for example, via capacitive or resistive methods, and conveyed to controller 234. It will be understood that, in other embodiments, other suitable touch-sensing mechanisms may be used, including vision-based mechanisms in which a camera receives an image of touch input display section 208 and/or images of the depressible keys via an optical waveguide. Such touch-sensing mechanisms may be applied to both touch regions and depressible keys, such that touch may be detected over one or more depressible keys in the absence of, or in addition to, mechanical actuation of the depressible keys.

The controller 234 may be configured to generate control commands based on the touch input signals received from touch input sensor 232 and/or key signals received via mechanical actuation of the one or more depressible keys. The control commands may be sent to a computing device via a data link 236 to control operation of the computing device. The data link 236 may be configured to provide wired and/or wireless communication with a computing device.

As described above, the touch images displayed on the depressible buttons and touch regions of active display regions of an adaptive input device can be changed to visually signal changing functionality of the buttons and/or the virtual controls. In order for a user to specify a desired functionality of a depressible button or touch region, the user can select a graphical image associated with a computing function from a menu on the display. This type of customization of an adaptive input device will now be described with respect to FIGS. 3-8.

FIG. 3 is a schematic depiction of an example computing system 300, including a computing device 310 and an adaptive input device 312. Computing system 300, may take the form of computing system 10 of FIG. 1A. Hence, adaptive input device 12 of FIG. 1A provides a non-limiting example of adaptive input device 312 of FIG. 3. Similarly, computing device 14 of FIG. 1A provides a non-limiting example of computing device 310 of FIG. 3.

Adaptive input device 312 includes an active display region 360. Active display region 360 may be one of a plurality of active display regions 362. In at least some embodiments, active display region 360 is a touch-sensitive graphical display or a depressible button for receiving touch input. Touch input may be received at active display region 360 via a touch input sensor 364 as previously described with reference to FIG. 2. Adaptive input device 312 further includes a passive display region 366. Passive display region 366 may be one of a plurality of passive display regions 368 of adaptive input device 312. One or more of passive display regions 368 and active display regions 362 may present graphical content as previously described with reference to FIGS. 1 and 2.

Computing device 310 may include a processor 314 for executing instructions that are held in one or more of memory 316 and mass storage 336. For example, memory 316 is shown with operating system 318 which may be executed by processor 314. Operating system 318 may include or provide one or more of an application programming interface (API) 320, an application hosting module 322, a user preference tool 324, and an adaptive device module 326.

Application hosting module 322 may be configured to host one or more applications, such as first application 340 and second application 346. In at least some embodiments, application hosting module is a desktop interface that supports one or more applications. As such, application hosting module may be configured to manage which application is a focus application of the adaptive input device at a particular instance where multiple applications are hosted at the application hosting module. Application hosting module 322 may be configured to retrieve applications from mass storage 336 where the applications may be hosted at application hosting module 322 when loaded into memory 316. Applications that are hosted at application hosting module 322 may communicate with operating system 318 via API 320.

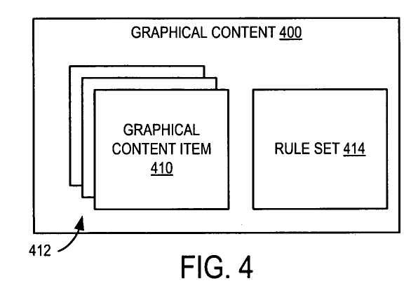

In at least some embodiments, user preference tool 324 may be provided to enable a user to create or modify a user preference. User preference tool 324 may be configured to receive graphical content to be presented at adaptive input device 312. For example, a user may upload graphical content (e.g., a photograph) to be displayed by the passive display regions and/or the active display regions under at least some circumstances. User preference tool 324 may also be configured to associate graphical content with a rule set, which defines how the adaptive device module is to vary the graphical content presented at the passive display region responsive to a change of the context of the adaptive input device. An example rule set is described in greater detail with reference to FIG. 4. In some embodiments, the rule set may specify that user-selected graphical content shall be visually presented under all circumstances. In some embodiments, user preference tool 324 may be configured to receive a user modification to the rule set to enable the user to change how the adaptive device module is to vary the graphical content presented at the passive display region. In this way, a user may customize the look and functionality of the adaptive input device.

Adaptive device module 326 may include one or more of an adaptive device input manager 328, an active display region manager 330, and a passive display region manager 332. Adaptive device input manager 328 may be configured to receive touch input from adaptive input device 312 and forward the touch input to the appropriate application (e.g., the focus application). Active display region manager 330 may be configured to direct the appropriate graphical content from an application or user preference to the active display region(s) of the adaptive input device to be displayed. Passive display region manager 332 may be configured to direct the appropriate graphical content from an application or user preference to the passive display region(s) of the adaptive input device to be displayed. Adaptive device module 326 may communicate with adaptive input device 312 via an adaptive device input/output interface 334.

Computing device 310 may include mass storage 336 that includes an application library 338 of one or more application programs. Application library 338 is shown in FIG. 3 including first application 340 and second application 346. First application 340 may include one or more of graphical content 342 for an active display region and graphical content 344 for a passive display region. Similarly, second application 346 may include one or more of graphical content 348 for an active display region and graphical content 350 for a passive display region. Mass storage 336 may also include user preferences 352, which may include one or more of graphical content 354 for an active display region and graphical content 356 for a passive display region.

In computing system 300, adaptive device module 326 may be configured to receive a touch input directed to active display region 360 of adaptive input device 312 via adaptive device input/output interface 334. Adaptive device module 326 may be further configured to direct the touch input received from adaptive input device 312 to a focus application of one or more applications that are hosted at application hosting module 322. Adaptive device module 326 may be further configured to present graphical content at passive display region 366 of adaptive input device 312. The graphical content may include one or more of static graphical content (e.g., one or more static images) and dynamic graphical content (e.g., video and/or animations).

Adaptive device module 326 may be further configured to vary the graphical content presented at the passive display region responsive to a change of a context of the adaptive input device. As a non-limiting example, adaptive device module 326 may be configured to vary the graphical content presented at passive display region 366 by animating the graphical content (e.g., by varying the graphical content between two or more different content items). In some embodiments and/or scenarios, graphical content presented by one or more active display regions may be varied in coordination with changes made to the passive display region(s).

In at least some embodiments, the change of the context of the adaptive input device may include a change of a parameter of a focus application. As a non-limiting example, the parameter may include a user state in the focus application. For example, where the focus application is a game, the user state may include a health level or point value of a character of the user in the game.

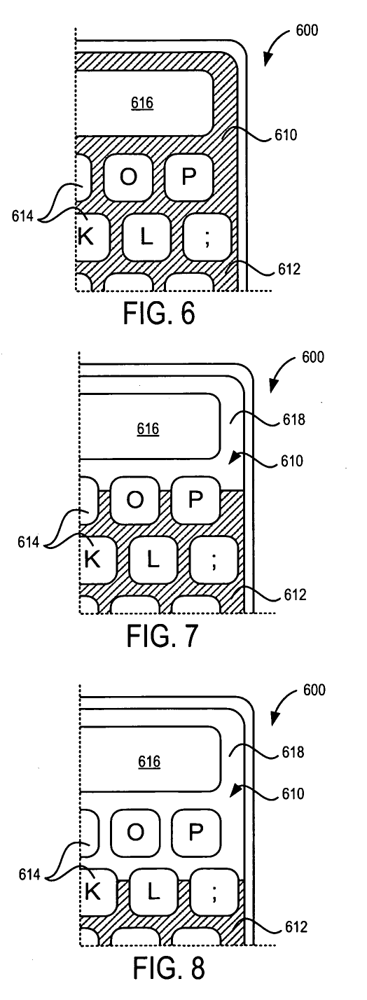

As further described with reference to FIGS. 6, 7, and 8, in at least some embodiments, the graphical content may include an indicator that graphically represents the parameter of the focus application. Adaptive device module may be configured to vary the graphical content presented at the passive display region by changing a relative amount of the passive display region that is occupied by the indictor in proportion to the parameter of the focus application. FIGS. 6, 7, and 8 provide a non-limiting example of an indicator that is changed to occupy different relative amounts of a passive display region of an adaptive device.

In at least some embodiments, the change of the context of adaptive input device 312 includes a change of the focus application from a first application (e.g., first application 340) to a second application (e.g., second application 346) of the one or more applications hosted at application hosting module 322. In this way, a visual appearance of the passive display region and/or the active display region may be varied as the user changes the focus application between a first application and a second application.

In the context of computing system 300, memory 316 and mass storage 336 collectively provide a data holding subsystem that holds or includes instructions that are executable by processor 314. These instructions may include one or more of operating system 318, first application 340, second application 346, and user preferences 352. In this way, the data holding subsystem may hold or include instructions that are executable by processor 314 to perform the various operations, functions, processes, and methods described herein.

FIG. 4 depicts graphical content 400 which provides a non-limiting example for one or more of graphical content 342, 344, 348, 350, 354, and 356 of FIG. 3. Graphical content 400 may include a graphical content item 410, which may be one of a plurality of graphical content items 412. As a non-limiting example, graphical content item 410 may include an individual static image or a dynamic video or animation. Graphical content 400 may further include a rule set 414, which defines the conditions for presenting the content items of the graphical content at one or more of the active display region and the passive display region of the adaptive input device. The adaptive device module may be configured to interpret the rule set in order to direct the appropriate graphical content to the adaptive input device.

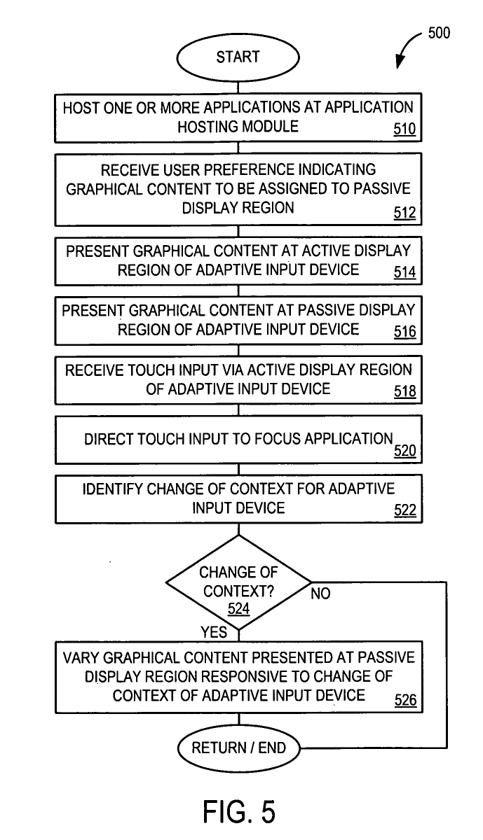

FIG. 5 is a flow chart depicting a method 500 of facilitating communication between a computing device and an adaptive device in a computing system. As a non-limiting example, FIG. 5 may be performed by computing system 300 of FIG. 3. While FIG. 5 depicts a number of processes, it should be appreciated that one or more of these processes may be omitted or repeated in some embodiments.

At 510, the method may include hosting one or more applications at an application hosting module. As one example, the application hosting module may retrieve one or more applications from mass storage into memory.

At 512, the method includes receiving a user preference indicating graphical content to be assigned to one or more of the active display region and the passive display region of the adaptive input device. As one example, the user preference may be retrieved (e.g., by adaptive device module 326 of FIG. 3) from mass storage or a user preference tool, which enables a user to create or modify the user preference.

In at least some embodiments, the user preference indicates a rule set and the graphical content to be presented at one or more of the active display region and the passive display region. For example, as previously described with reference to FIG. 4, a rule set may be associated with the graphical content, which directs the adaptive device module how one or more content items of the graphical content are to be presented at active display region or the passive display region.

At 514, the method includes presenting graphical content at an active display region of an adaptive input device. As previously described with reference to FIG. 3, an adaptive device module may retrieve graphical content for the active display from the focus application and transmit the graphical content to the active display region of the adaptive input device where it may be displayed.

At 516, the method includes presenting graphical content at a passive display region of the adaptive input device. As previously described with reference to FIG. 3, an adaptive device module may retrieve graphical content for the passive display from the focus application and transmit the graphical content to the passive display region of the adaptive input device where it may be displayed.

The graphical content presented at the passive display region may include one or more of static graphical content and dynamic graphical content. As a non-limiting example, the graphical content presented at the passive display region may include an indicator that graphically represents a parameter of a focus application. Where a user preference is set by the user, the process of presenting the graphical content at the passive display region of the adaptive input device may be performed in accordance with a rule set of the user preference.

At 518, the method may include receiving touch input via the active display region of the adaptive input device. As previously described with reference to FIGS. 1-3, the process of receiving the touch input via the active display region may include receiving the touch input via a touch-sensitive graphical display or a depressible button of the active display region.

At 520, the method includes directing the touch input that is received at 518 to a focus application of the one or more applications hosted at the application hosting module. For example, the touch input may be received at an adaptive device module where it is directed to the focus application.

At 522, the method may include identifying a change of a context of the adaptive input device. As previously described with reference to FIG. 3, the change of the context of the adaptive input device may include a change of a parameter of the focus application. As another example, the change of the context of the adaptive input device may include a change of the focus application from a first application of the one or more applications hosted at the application hosting module to a second application of the one or more applications hosted at the application hosting module. As yet another example, the change of the context of the adaptive input device may include a change of a user preference by the user.

At 524, if a change of the context is identified at 522, then the process flow of method 500 may proceed to 526. Alternatively, if a change of the context is not identified at 522, then the process flow may return or end.

At 526, the method includes varying the graphical content presented at the passive display region responsive to a change of the context of the adaptive input device. In at least some embodiments, varying the graphical content presented at the passive display region includes changing which content item is presented at the passive display region in accordance with the rule set of the graphical content. For example, the graphical content may be varied by changing the graphical content that is presented at the passive display region from a first image or video to a second image or video. As a non-limiting example, varying the graphical content presented at the passive display region may include changing a relative amount of the passive display region that is occupied by an indictor in proportion to a parameter of the focus application. In at least some embodiments, the parameter of the focus application may include a user state in the focus application (e.g., health meter, speed meter, time-left indicator, etc.). As another example, varying the graphical content presented at the passive display region may include changing a skin to signal which application has focus relative to the adaptive input device.

FIGS. 6, 7, and 8 depict a sequence of events relating to a partial view of an example adaptive input device 600. In each of FIGS. 6, 7, and 8 adaptive input device 600 includes a passive display region 610 and several active display regions, including depressible buttons 614 and touch-sensitive graphical display 616. Further, as shown in FIG. 6, passive display region 610 of adaptive input device 600 substantially surrounds one or more of the active display regions.

FIGS. 6, 7, and 9 further depict how graphical content in the form of an indicator 612 may be presented at the passive display region, whereby the graphical content is varied by changing a relative amount of the passive display region that is occupied by the indictor. The relative amount of the passive display region that is occupied by the indicator may be varied by the computing system in proportion to a parameter of a focus application.

In FIG. 6, for example, a first indicator 612 (represented by shading) is shown occupying a greater amount of passive display region 610 than in FIG. 7. Similarly, FIG. 7 shows indicator 612 occupying a greater amount of passive display region 610 than in FIG. 8. Conversely, a second indicator 618, which is inversely proportional to first indicator 612, is shown occupying a lesser amount of the passive display region 610 in FIG. 7 than in FIG. 8. Hence, passive display region 610 may be operated to provide visual feedback to the user. As previously described, indicator 612 may be used by the computing system to graphically represent a parameter of the focus application, such as a user state in the focus application.

As a first non-limiting example, the focus application may include a game and the user state in the game may include a health level or point value of the user's game character. As the health level of the user's character increases or decreases throughout the game, the computing system may vary the relative amount (e.g., level) of the passive display region that the indicator occupies. For example, the second indicator 618 may be a green color to represent good health. As the health of the character suffers throughout the game, the green indicator may recede, thus signaling danger to the user. As the green indicator recedes, a more gruesome animation of blood and carnage, schematically shown as first indicator 612, may be revealed, so that the adaptive input device appears to be awash in blood as the character's health declines.

As another non-limiting example, the parameter of the focus application may include a time parameter. As the time parameter changes, the computing system may graphically convey the time parameter to the user by changing the relative amount of the passive display region that is occupied by one or more of the indicator. As an example, the passive display region may graphically display a countdown timer as a receding indicator (e.g., first indicator 612) and/or an elapsed time timer as a second indicator 618.

While FIGS. 6, 7, and 8 do not show the active display regions changing as the passive display region changes, it is to be understood that the active display regions may also be changed. As an example, as the passive display region is filled with an indicator, the active display regions (e.g., buttons) can be filled in a likewise manner.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A computing system, comprising:
an adaptive input device including an active display region for receiving touch input and a passive display region for presenting graphical content;
a computing device operatively coupled with the adaptive input device and including an adaptive device module, the adaptive device module configured to:
receive a touch input via the active display region of the adaptive input device;
present graphical content at the passive display region of the adaptive input device; and
vary the graphical content presented at the passive display region responsive to a change of a context of the adaptive input device.

2. The computing system of claim 1, where the active display region is a touch-sensitive graphical display or a depressible button for receiving the touch input.

3. The computing system of claim 2, where the passive display region of the adaptive input device substantially surrounds the active display region.

4. The computing system of claim 1, where the computing device further includes an application hosting module configured to host one or more applications;
where the adaptive device module is further configured to direct the touch input to a focus application of the one or more applications hosted at the application hosting module; and
where the change of the context of the adaptive input device includes a change of a parameter of the focus application.

5. The computing system of claim 4, where the graphical content includes an indicator that graphically represents the parameter of the focus application; and
where the adaptive device module is configured to vary the graphical content presented at the passive display region by changing a relative amount of the passive display region that is occupied by the indictor in proportion to the parameter of the focus application.

6. The computing system of claim 5, where the parameter of the focus application includes a user state in the focus application.

7. The computing system of claim 1, where the computing device further includes an application hosting module configured to host one or more applications;
where the adaptive device module is further configured to direct the touch input to a focus application of the one or more applications hosted at the application hosting module; and
where the change of the context of the adaptive input device includes a change of the focus application from a first application of the one or more applications to a second application of the one or more applications hosted at the application hosting module.

8. The computing system of claim 1, where the graphical content includes one or more of static graphical content and dynamic graphical content.

9. The computing system of claim 1, where the adaptive device module is configured to vary the graphical content presented at the passive display region by animating the graphical content.

10. The computing system of claim 1, where the computing device further includes a user preference tool configured to:
receive the graphical content; and
associate the graphical content with a rule set, the rule set defining how the adaptive device module is to vary the graphical content presented at the passive display region responsive to the change of the context of the adaptive input device; and
receive a user modification to the rule set to change how the adaptive device module is to vary the graphical content presented at the passive display region responsive to the change of the context.

11. In a computing system, a method comprising:
receiving a touch input via an active display region of an adaptive input device;
presenting graphical content at a passive display region of the adaptive input device; and
varying the graphical content presented at the passive display region responsive to a change of a context of the adaptive input device.

12. The method of claim 11, further comprising:
hosting one or more applications at an application hosting module;
directing the touch input to a focus application of the one or more applications hosted at the application hosting module; and
where the change of the context of the adaptive input device includes a change of a parameter of the focus application.

13. The method of claim 12, where the graphical content includes an indicator that graphically represents the parameter of the focus application; and
where varying the graphical content presented at the passive display region includes changing a relative amount of the passive display region that is occupied by the indictor in proportion to the parameter of the focus application.

14. The method of claim 13, where the parameter of the focus application includes a user state in the focus application.

15. The method of claim 11, further comprising:
hosting one or more applications at an application hosting module;
directing the touch input to a focus application of the one or more applications hosted at the application hosting module; and
where the change of the context of the adaptive input device includes a change of the focus application from a first application of the one or more applications to a second application of the one or more applications hosted at the application hosting module.

16. The method of claim 11, where the graphical content includes one or more of static graphical content and dynamic graphical content.

17. The method of claim 11, where receiving the touch input via the active display region includes receiving the touch input via a touch-sensitive graphical display or a depressible button of the active display region.

18. The method of claim 11, further comprising:
receiving a user preference at a user preference tool, the user preference indicating a rule set and the graphical content to be presented at the passive display region;
where the change of the context of the adaptive input device includes a change of the user preference by the user; and
where presenting the graphical content at the passive display region of the adaptive input device is performed in accordance with the rule set.

19. A data holding subsystem including instructions executable by a processor to:
receive a touch input via the active display region of the adaptive input device;
direct the touch input to a focus application;
present graphical content at the passive display region of the adaptive input device; and
vary the graphical content presented at the passive display region responsive to a change of a parameter of the focus application.

20. The data holding subsystem of claim 19, where the graphical content includes an indicator that graphically represents the parameter of the focus application; and
where the data holding subsystem further includes instructions executable by the processor to vary the graphical content presented at the passive display region by changing a relative amount of the passive display region that is occupied by the indictor in proportion to the parameter of the focus application; and
where the parameter of the focus application includes a user state in the focus application.
